(19) United States
(12) Patent Application Publication
(10) Pub. No.: US 2011/0201717 A1
(43) Pub. Date: Aug. 18, 2011

(54) ACTINICALLY CURABLE ADHESIVE COMPOSITION

(75) Inventors: Robert Paul Held, Newark, DE (US); Hassan Modamed Farah, Diamond Bar, CA (US)

(73) Assignee: E. I. DU PONT DE NEMOURS AND COMPANY, Wilmington, DE (US)

(21) Appl. No.: 12/810,175

(22) PCT Filed: Dec. 29, 2008
(86) PCT No.: PCT/US2008/088387

§ 371 Date: Nov. 12, 2010

Related U.S. Application Data
(60) Provisional application No. 61/009,406, filed on Dec. 28, 2007.

(51) Int. Cl. C09J 4/02; C08K 5/092; C08K 5/07

(52) U.S. Cl. 522/33; 522/96; 522/64; 522/79

(57) ABSTRACT

A photocurable adhesive composition is disclosed herein that has high adhesive strength and optical clarity and which in the cured state is reworkable and exhibits low propensities for exhibiting glow mark and pooling effects. The composition contains a chain transfer agent, an urethane (meth)acrylate having a plurality of ethylenically unsaturated groups, a (meth)acrylate monomer and a photoinitiator. The composition may optionally contain a light stabilizer.

### FIELD OF THE INVENTION

The invention is directed to an actinically curable (photocurable) adhesive composition.

### BACKGROUND OF THE INVENTION

In today's market, flat panel displays, such as liquid crystal displays (LCD), are often enhanced with specialized films. The films may be flexible or rigid. Such films are designed to optimize optical performance, e.g., viewing contrast, increasing brightness, removing glare, enhancing color and enhancing the clarity of the flat panel display. The films are typically applied to the viewing side of the display. Application methods involve the use of an adhesive that is optically clear and pressure sensitive for easy bonding directly to the display.

Curable adhesives (e.g., heat or light cured) have been used in applications where substrates require substantial permanency and high strength adherence. Conventional curable adhesives, however, are typically not easy to apply, such as a tape. An adhesive material for application of a film to a base material is described in U.S. Pat. No. 6,139,953. For optical product applications (e.g., glazings), curable adhesives have been desirable, as they can provide optically clear, strongly adhered laminates (e.g., layered substrates).

To achieve both strength and ease of application, hybrid compositions have been developed that can be used in optical applications. For example, a light curable, polyester based adhesive has been used for plastic glazing applications. In digital video disc (DVD or optical discs) bonding and cathode ray tube (CRT) applications, a liquid adhesive formulation has been used. For bead bonding in making retroreflective articles, a curable polymeric network has been suggested.

Strength and application, however, are not the only criteria that many optical substrates/laminates require. Certain optical products are exposed to harsh environmental conditions, such as heat, UV (solar) light, water, etc. For example, vehicle windshields generally exist in outdoor conditions that submit them to all types of weather. These windshields typically include substrates such as acrylic or polycarbonate, adhered to a solar or infra-red (IR) reflecting film made from a multi-layer optical film (MLOF) (3M Co., St. Paul, Minn.). The materials may become optically obstructed if the adhesion between the layers is damaged or compromised.

Light curable liquid acrylic ester adhesives for glass bonding using low intensity ultraviolet (“UV”) light are known. Such adhesives are useful for glass assembly and repair applications in which high intensity UV light is unavailable or impractical.

A number of fast curing low-yellowing acrylate functional oligomer products are known for use in UV/electron beam (“EB”) curable printing inks and the like. However, such products typically have poor adhesive strength to glass.

It is desirable and often necessary for a viable commercial UV/visible curable adhesive suitable for glass bonding to possess several key properties—e.g., having good adhesive strength, fast tack-free time, optical clarity and reduced yellowing. Additional key properties that are highly desirable in an optical adhesive (in the cured state) targeted for use in display applications include reworkability and low propensities for exhibiting undesirable pooling and glow marks in products bonded with the adhesive. Present commercially-available adhesives fall short with regard to one or more of these key properties. The present invention offers a solution to attain this need/desire.

### SUMMARY OF THE INVENTION

In an embodiment, the invention is an actinically curable adhesive composition comprising:
a) an aliphatic urethane acrylate having a plurality of ethylenically unsaturated groups;
b) a monofunctional monomer;
c) a photoinitiator;
d) a plasticizer; and
e) a chain transfer agent.

In another embodiment, the invention is an actinically curable adhesive composition comprising:
a) an aliphatic urethane acrylate having a plurality of ethylenically unsaturated groups;
b) a monofunctional monomer selected from the group consisting of phenoxyethyl acrylate and trimethylolpropane formal acrylate;
c) a photoinitiator;
d) a plasticizer; and
e) a chain transfer agent.

In another embodiment, the invention is an actinically curable adhesive composition comprising:
a) an aliphatic urethane acrylate having a plurality of ethylenically unsaturated groups;
b) a monofunctional monomer;
c) a photoinitiator selected from the group consisting of a difunctional alpha-hydroxy ketone, 1-hydroxycyclohexylphenyl ketone, and 2,4,6- trimethylbenzoylphenylphosphine oxide;
d) a plasticizer; and
e) a chain transfer agent.

In another embodiment, the invention is an actinically curable adhesive composition comprising:
a) an aliphatic urethane acrylate having a plurality of ethylenically unsaturated groups;
b) a monofunctional monomer;
c) a photoinitiator;
d) a plasticizer; and
e) a chain transfer agent selected from the group consisting of pentaerythritol tetrakis(3-mercaptopropionate), 2-mercaptobenzothiazole, 2-mercaptobenzoxazole, 4-methyl-4H-1,2,4-triazole-3-thiol; N- phenylglycine, 1,1-dimethyl-3,5-diketocyclohexane, 2- mercaptobenzimidazole, pentaerythritol tetrakis (mercaptoacetate), 4- acetamidothiophenol, mercaptosuccinic acid, dodecanethiol, and beta-mercaptoethanol.

In another embodiment, the invention is an actinically curable adhesive composition comprising:
a) an aliphatic urethane acrylate having a plurality of ethylenically unsaturated groups;
b) a monofunctional monomer;
c) a photoinitiator;
d) a plasticizer; and
e) pentaerythritol tetrakis(3-mercaptopropionate).

In another embodiment, the invention is an actinically curable adhesive composition comprising:
a) an aliphatic urethane acrylate having a plurality of ethylenically unsaturated groups;
b) a monofunctional monomer;
c) a photoinitiator;
d) a plasticizer selected from the group consisting of dibutoxyethoxyethyl adipate and dibutoxyethoxyethyl formal; and
e) a chain transfer agent.

### GLOSSARY OF TERMS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements, but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

### DETAILED DESCRIPTION OF THE INVENTION

In various embodiments, the invention is an actinically curable adhesive composition comprising:
a) an aliphatic urethane acrylate having a plurality of ethylenically unsaturated groups;
b) a monofunctional monomer;
c) a photoinitiator;
d) a plasticizer; and
e) a chain transfer agent.

All weight percentages found herein are based on total composition, and all ranges include any range or value contained therein.

The chain transfer agent may be present in the adhesive compositions in an amount ranging from about 4-10 weight % and preferably from about 5-9 weight If the level of chain transfer agent is less than approximately 4 weight %, the adhesive upon curing will be too stiff, and it will have too high a modulus, such that undesirable pooling and “halo” effects (e.g., glow marks) in LCD displays will likely result when the adhesive of this composition is utilized in LCD displays. If the level of the chain transfer agent is greater than approximately 10 weight %, the adhesive upon curing will lack sufficient strength to be suitable in display applications.

In an embodiment, the chain transfer agent may be selected from pentaerythritol tetrakis(3-mercaptopropionate) (PETAMAP), 2- mercaptobenzothiazole (2-MBT), 2-mercaptobenzoxazole (2-MBO), 4- methyl-4H-1,2,4-triazole-3-thiol (MMT); N-phenylglycine, 1,1-dimethyl-3,5- diketocyclohexane, 2-mercaptobenzimidazole, pentaerythritol tetrakis (mercaptoacetate), 4-acetamidothiophenol, mercaptosuccinic acid, dodecanethiol, and beta-mercaptoethanol. In another embodiment, the chain transfer agent may be selected from pentaerythritol tetrakis(3- mercaptopropionate) (PETAMAP), 2-mercaptobenzothiazole (2-MBT), 2- mercaptobenzoxazole (2-MBO), and 4-methyl-4H-1,2,4-triazole-3-thiol (MMT). In yet another embodiment, the chain transfer agent is pentaerythritol tetrakis(3-mercaptopropionate) (PETAMAP). In yet still another embodiment, the chain transfer agent is not limited to any particular compounds, and the chain transfer agent may be any of the above recited compounds or the chain transfer agent can be other compounds including, but not limited to, carbon tetrabromide, dimethylaniline, ethanethiol, butanethiol, t-butyl mercaptan, thiophenol, and ethyl mercaptoacetate.

The composition of this invention includes a photopolymerizable urethane (meth)acrylate having a plurality of ethylenically unsaturated groups. The urethane (meth)acrylate can either be a urethane acrylate or a urethane methacrylate and is preferably a urethane acrylate. In an embodiment, the urethane (meth)acrylate is an aliphatic urethane diacrylate. The urethane (meth)acrylate is present in the composition in the range of about 30-60 weight % based on total composition. If the level of urethane (meth)acrylate is greater than approximately 60 weight %, the solution viscosity of the composition is too high and, consequently, the composition is not amenable to necessary degassing prior to photocuring. If the level of urethane (meth)acrylate is less than about 30 weight %, the solution viscosity is too low and, consequently, the cured adhesive is dry/hard and is not sticky or flexible. These properties in the cured adhesive are undesirable in that they correspond to the cured adhesive having high propensities for displays bonded using these adhesives to exhibit undesirable pooling and glow mark effects as well as for displays bonded with these adhesives to not be reworkable. Furthermore, such undesirable properties may lead to delamination of displays.

In some embodiments, the urethane (meth)acrylate may be selected from CN-9002 (Sartomer Company, Exton, Pa.), Ebecryl® 230 (aliphatic urethane diacrylate), Ebecryl® 244 (aliphatic urethane diacrylate diluted 10% with 1,6-hexanediol diacrylate), Ebecryl® 264 (aliphatic urethane triacrylate diluted 15% with 1,6-hexanediol diacrylate), Ebecryl® 284 (aliphatic urethane diacrylate diluted 10% with 1,6-hexanediol diacrylate), CN-961 E75 (aliphatic urethane diacrylate blended with 25% ethoxylated trimethylol propane triacrylate), CN-961 H81 (aliphatic urethane diacrylate blended with 19% 2(2-ethoxyethoxy)ethyl acrylate), CN-963A80 (aliphatic urethane diacrylate blended with 20% tripropylene glycol diacrylate), CN-964 (aliphatic urethane diacryate), CN-966A80 (aliphatic urethane diacrylate blended with 20% tripropylene glycol diacrylate), CN-982A75 (aliphatic urethane diacrylate blended with 25% tripropylene glycol diacrylate) and CN-983 (aliphatic urethane diacrylate), FAIRAD 8010, FAIRAD 8179, FAIRAD 8205, FAIRAD 8210, FAIRAD 8216, FAIRAD 8264, M-E-15, UVU-316, ALU-303, and Genomer 4652. In one embodiment, the urethane (meth)acrylate is Sartomer CN-9002 (aliphatic urethane diacrylate). Additional examples of suitable commercially-available urethane (meth)acrylates include CN963, CN964, CN965, CN966, CN970, CN973, and CN990, all of which are available from Sartomer (Exton, PA). Ebecryl® urethane (meth)acrylates are available from Cytec Surface Specialties, Brussels, Belgium. Urethane (meth)acrylates listed above with a CN-xxx designation are available from Sartomer (Exton, PA). FAIRAD urethane (meth)acrylates are available from Fairad Technology Inc., Morrisville, Pa. M-E-15, UVU-316, ALU-303, and Genomer 4652 urethane (meth)acrylates are, respectively, available from Rahn AG (1005 N' Commons Drive, Aurora, Ill.).

In various embodiments, the urethane (meth)acrylate can have a formula (I):

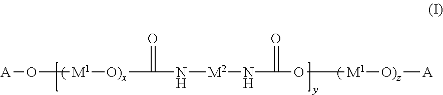

Each M¹ is, independently, an alkylene, an acylalkylene, an oxyalkylene, an arylene, an acylarylene, or an oxyarylene. Each M² is, independently, an alkylene or an arylene. Each M¹ and each M² are optionally substituted with alkyl, cycloalkyl, alkenyl, cycloalkenyl, alkynyl, acyl, alkoxy, hydroxyl, hydroxyalkyl, halo, haloalkyl, amino, silicone, aryl, or aralkyl. In formula (I), x is a positive integer less than 40, y is a positive integer less than 100, and z is a positive integer less than 40. Each A, independently, has the formula:

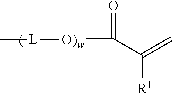

R¹ is hydrogen or lower alkyl, each L is, independently, C₁-C₄ alkyl, and w is an integer ranging from 0 to 20. In formula (I), w, x, y, and z together are selected such that the molecular weight of the urethane (meth)acrylate is less than 20,000. More particularly, M¹ can be acylalkylene and M² can be alkylene or arylene.

A (meth)acrylate monomer is another component of the compositions of this invention. The (meth)acrylate monomer may contain 7-18 carbon atoms, preferably 9-15 carbon atoms, and more preferably 9-12 carbon atoms in addition to oxygen and hydrogen atoms and optionally other atoms (e.g., sulfur, nitrogen). The carbon atoms can be present as either aromatic or aliphatic groups. Non-limiting examples of methacrylate monomers include cyclic trimethylolpropane formal acrylate (SR-531 from Sartomer Co., Exton, Pa.) and 2-phenoxyethyl acrylate (SR-339 from Sartomer Co., Exton, Pa.) In one more preferred embodiment, a phenoxyalkyl group (e.g., 2-phenoxyethyl) is present in the monomer. The (meth)acrylate monomer is mono-functional. The (meth)acrylate monomer is present in a range of about 10 weight percent to about 40 weight percent and preferably from about 12 weight percent to about 33 weight percent. In some embodiments, the (meth)acrylate monomer is present in a range of about 14 weight percent to about 33 weight percent.

A plasticizer is another component of the compositions of this invention. In an embodiment, the plasticizer can be any compound or class of compounds known to exhibit plasticizer properties. In another embodiment, the plasticizer can be any plasticizer or class of plasticizers that are disclosed in “The Technology of Solvents and Plasticizers”, by

Arthur K. Doolittle, John Wiley & Sons, Inc., New York, 1954; see Chapters 15 and 16 in particular. In another embodiment, non-limiting examples of suitable plasticizers include, but are not limited to, dibutoxyethoxyethyl formal (Cyroflex SR660) or dibutoxyethoxyethyl adipate (Wareflex SR650), both of which are available from Sartomer Company (Exton, Pa). In another embodiment, the plasticizer is di butoxyethoxyethyl formal (Cyroflex SR660) or di butoxyethoxyethyl adipate (Wareflex SR650), both of which are available from Sartomer Company (Exton, Pa.). The plasticizer is present in a range of about 10 weight percent to about 40 weight percent, preferably from about 20 weight percent to about 35 weight percent, and more preferably from about 25 weight percent to about 35 weight percent. In some embodiments, the plasticizer is present in a range of about 15 weight percent to about 30 weight percent.

In this invention, there are ranges for the levels added together (meth)acrylate monomer and plasticizer that are suitable. Broadly, the level of (meth)acrylate monomer plus the level of plasticizer (added together) can range from about 30 weight percent to about 50 weight percent, preferably can range from about 35 weight percent to about 50 weight percent, and more preferably can range from about 40 weight percent to about 48 weight percent. If the level of the (meth)acrylate monomer plus the level of the plasticizer is greater than about 50 weight %, the solution viscosity is low and consequently, the cured adhesive is dry/hard and is not sticky (desirable) or flexible; these properties in the cured adhesive are not amenable to reworkability of the cured adhesive when necessary and may lead to delamination of displays manufactured using adhesives with such properties. If the level of the (meth)acrylate monomer plus the level of the plasticizer is less than about 30 weight %, the solution viscosity of the composition is high and, consequently, the composition is not amenable to necessary degassing prior to photocuring.

To initiate polymerization of the monomers upon exposure to actinic radiation, the composition of this invention includes a photoinitiator or photoinitiator system. Suitable photoinitiators include, but are not limited to, difunctional alpha-hydroxy ketone (Esacure® ONE from Sartomer Co., Exton, Pa.), 2,4,6-trimethylbenzoyldiphenylphosphine oxide (Esacure® TPO from Sartomer Co., Exton, Pa.), Irgacure® 184 (1-hydroxycyclohexyl phenyl ketone), Irgacure® 907 (2-methyl-1-[4-(methylthio)phenyl]-2- morpholino propan-1-one), Irgacure® 392 (2-benyl-2-N,N-dimethylamino- 1-(4-morpholinophenyl)-1-butanone), Irgacure® 500 (the combination of 50% 1-hydroxy cyclohexyl phenyl ketone and 50% benzophenone), Irgacure® 651 (2,2-dimethoxy-1,2-diphenylethan-1-one), Irgacure® 1700 (the combination of 25% bis(2,6-dimethoxybenzoyl-2,4-,4-trimethyl pentyl) phosphine oxide, and 75% 2-hydroxy-2-methyl-1-phenyl-propan-1-one), DAROCUR® 1173 (2-hydroxy-2-methyl-1-phenyl-1-propane), and DAROCUR® 4265 (the combination of 50% 2,4,6-trimethylbenzoyldiphenyl-phosphine oxide and 50% 2-hydroxy 2-methyl-1-phenyl-propan-1-one); these photoinitiators are available commercially from Ciba-Geigy Corp., Tarrytown, N.Y. Some additional suitable photoinitiators are CYRACURE® UVI-6974 (mixed friaryl sulfonium hexafluoroantimonate salts) and CYRACURE® UVI-6990 (mixed friaryl sulfonium hexafluorophosphate salts) available commercially from Union Carbide Chemicals and Plastics Co., Inc., Danbury, Conn.; and Genocure® CQ, Genocure® BOK, and Genocure® M.F., commercially available from Rahn Radiation Curing ; and others include benzophenone, 2-hydroxy-2-phenyl acetophenone, benzoin isopropyl ether, 2,4,6-trimethyl benzoyl diphenylphosphine oxide, methylphenyl glyoxylate, 1-phenyl-1,2- propane dion-2-o-ethoxycarbonyl oxime, and substituted and unsubstituted hexaphenyl biimidazole dimmers. Preferred photoinitiators include Esacure® ONE and Esacure® TPO, both from Sartomer Co., Exton, Pa. Combinations of these materials may also be employed herein. The photoinitiator may be present in the adhesive compositions in an amount ranging from about 0.1-2 weight % of the total composition and preferably is present in an amount ranging from about 0.5-1.2 weight % of the total composition. If the photoinitiator is present at a level that is less than about 0.1 weight %, the cure rate is too low to be acceptable and/or is near zero. If the photoinitiator is present at a level that is greater than about 2 weight %, there is no advantage in having a higher level and/or the propensity of the composition to yellow may be increased.

The photocurable adhesive composition as described above may optionally include a light stabilizer. Some non-limiting examples of suitable light stabilizers are Tinuvin® 292 (bis(1,2,2,6,6-pentamethyl-4- piperidyl)sebacate and 1-methyl-10-(1,2,2,6,6-pentamethyl-4- piperidyl)sebacate), and Tinuvin® 765 (bis(1,2,2,6,6,-pentamethyl-4- piperidyl)sebacate) both available from Ciba Specialty Chemicals; BLS 292 (bis(1,2,2,6,6-pentamethyl-4-piperidyl)sebacate and 1-(methyl)-10- (1,2,2,6,6-pentamethyl-4-piperidyl)sebacate) available from Mayzo Inc.;

MEQH (4-methoxyphenol) available from Aldrich Chemical Company; and, LA-32 and LA-82 available from ADK Stab; and Chimassorb® 81 available from Ciba Specialty Chemicals. A stabilizer that is a hindered amine light stabilizer (HALS) is preferred. In one embodiment, a HALS stabilizer is selected from the group consisting of Tinuvin® 765 (bis(1,2,2,6,6- pentamethyl-4-piperidyl)sebacate) and Tinuvin® 292 (bis(1,2,2,6,6- pentamethyl-4-piperidyl)sebacate and 1-(methyl)-10-(1,2,2,6,6- pentamethyl-4-piperidyl)sebacate). Both Tinuvin® 765 and Tinuvin® 292 are available from Ciba Specialty Chemicals. In another embodiment, Tinuvin® 765 (bis(1,2,2,6,6-pentamethyl-4-piperidyl)sebacate) is the light stabilizer.

When present in the composition, the light stabilizer can be present in an amount ranging from about 0.01-0.1 weight %, preferably about 0.01-0.06 weight %, more preferably about 0.025-0.075 weight %, and still more preferably about 0.025-0.050 weight %, based on the total composition. When the level of stabilizer is above about 0.1 weight % in a composition, the viscosity of the uncured composition may increase with time (over less than or equal to 3 months) to an unacceptable level for there to be adequate product shelf life. When the level of stabilizer is below about 0.010 weight %, its effectiveness as a light stabilizer is poor.

While not being bound by any theory, the inventors believe that the levels of plasticizer and chain transfer agent are particularly important for the compositions of their invention such that the cured compositions will have suitable balance of stiffness and softness to afford good adhesion, impart reworkability in devices using the adhesive, and reduce or eliminate the undesirable effects of glow marks and pooling. Increasing the level of either chain transfer agent or plasticizer in the inventive compositions affords a softer polymer in the cured state having lower modulus.

### Definitions

Glow mark—A glow mark is a visual aberration/deformity in the appearance of an LCD when a portion of the LCD is under more stress than other portions of it. An LCD having a glass plate, for example, bonded to it with an adhesive, can have portions (particularly near the edges) that are under higher stress if the modulus of the cured adhesive is too high. In this case, this bonded LCD may exhibit glow marks which are undesirable. In this invention, glow marks are rated for their severity using the following 0-5 scale:
0=No glow mark observed
1=Glow mark(s) just visible off-axis or on-axis, light yellow
2=Glow mark(s) obvious on-axis, medium yellow
3=See objectionable discoloration, heavy yellow
4=See severe discoloration, golden yellow-light brown
5=See dark yellow-brown
   The glow mark tests reported in Table 1 were done at 50° C.
   Pooling—Pooling is an undesirable pressure-induced distortion of an LCD panel such that the LCD display being subjected to pressure is susceptible to exhibiting a wave motion of liquid crystal material that is undesirable in comparison to a uniform display under pressure that exhibits no such observable pressure-induced defects. Pooling is particularly undesirable in notebook tablet displays where a stylus is used to write information to the display since irrelevant information is observable on the display that is distracting and precludes having a desirable uniform display background. In this invention, pooling effects in adhesively bonded displays are rated for their severity using the following 0-5 scale:
0=No pooling observed
1=Slight pooling near edge(s)
2=Medium low level of pooling
3=Medium level of pooling
4=Medium high level of pooling
5=High level of pooling equal to or greater than that of Comparative Sample 11 from Table 1
   The pooling ratings reported in Table 1 were determined at ambient temperature.
   Reworkability—Reworkability of an adhesively-bonded display (e.g., LCD) in this invention is defined to mean that the cured bonded adhesive when desired or necessary can without undue difficulty or long time requirement(s) be cleanly and effectively removed during disassembly of the display to remove a substrate (e.g., film or glass plate) from being bonded to the display by the cured adhesive layer. An example of where reworkability is desired is when an air bubble or other defect is found in a bonded display. In this event, it is highly desirable that the substrate and adhesive be removed from the display such that the bonding process can be repeated to afford a bonded display but without the flaw being present in reworking. If reworking is not feasible, then the defective bonded display cannot typically be corrected and is usually then discarded, which corresponds to a relatively high value loss of the display as well as the film or plate.

More specifically, a cured adhesive that is reworkable is one that is compatible with a wire or other rework tool to be drawn/sliced through it and afford a basically clean separation of adhesive from the LCD panel without the adhesive having a significant propensity to rebond with itself and reform the adhesion between the sliced adhesive layer on the LCD panel. Furthermore, a good adhesive from the reworkability standpoint is one in which the separated cured adhesive tends to collect in a few clumps (after the adhesive layer has been sliced through) such that an operator can readily manually remove the adhesive from the LCD and glass plate (both now being separated from each other following slicing) within a relatively short time.

### EXAMPLES

### Adhesive Samples

Samples of the different adhesive compositions shown in Table 1 were made up with the component levels as shown in Table 1 (in weight percent units). Adhesive batch sizes for these compositions were in range of 500-2500 grams.

### Test Methods

Test methods and parameters as well as key information defining each test type are given below.

### Tensile Measurements

Tensile measurements of elastic modulus and the engineering stress at 33% strain were made using straight sided strips (nominally 127 mm×30 mm×1.5 mm) of cured resin on a universal materials tester manufactured by Instron (Canton, Mass.). The tensile tests were conducted at 24° C. at a test rate of 279 mm/min with an intial grip separation of 76 mm. The strain was calculated using the initial grip separation. The stress was calculated using the initial dimensions. The resulting stress-strain plots afforded elastic modulus values reported (see Table 1) in mPA (milliPascals).

### Bonding Preparation Using LCD Fixture

An LCD fixture was prepared for bonding an LCD to a glass plate using a given photocurable adhesive sample and also using a dam technique in a laboratory method which confines uncured liquid adhesive only in areas where bonding is desired.. The dam used was a raised tape edging together with shims to define the thickness level of cured adhesive. The adhesive was poured into the “dammed” area of the fixture. The glass was then placed onto the adhesive with the adhesive spread out so there were no visible air bubbles. This fixture was then UV light cured to yield a photocured adhesive layer between the glass and the LCD fixture (polarizer surface) using UV light equipment discussed below.

### Curing and Testing of Adhesive Cured Samples

The UV light was a Fusion UV conveyor belt transport using a Fuson UV “D” bulb. The intensity was set at 2.813 W/cm2 with the exposure being about 6.77 J/cm2. The fixture was transported through the exposure unit at about 3 ft./min. The samples used to measure the modulus and mean stress vs strain curves were made in a teflon coated steel fixture with a well about 2 inches by 6 inches with a depth of about 2 mm. The liquid adhesive is placed in this fixture well and sent through the UV curing Fusion light source to provide a cured “strip” of adhesive which is placed in an Instron unit to measure the pull forces which yields a stress versus strain curve of the cured adhesive layer.

### Reworkability Testing

In the reworkability experiments reported in Table 1 for various adhesive compositions, a given adhesive was used to bond a glass plate to either a NEC or Toshiba LCD panel. To test reworkability, a given bonded LCD panel was heated and then a wire was used to “slice through” the adhesive layer and to thereby initiate separation of the glass plate from the LCD at the adhesive interface. The wire was held at both ends by a technician such that it had a U-shape as it was drawn through the cured adhesive layer to effect de-bonding.

Two levels of reworkability are reported in Table 1. In “Pass-level 1”, an operator can using a wire tool slice through and remove the adhesive from the LCD and glass within a short period of less than or equal to 2 minutes without damaging the LCD and cover plate surfaces and. In “Pass-level 2”, an operator can remove the adhesive but its removal is not as clean and requires a longer time than two minutes.

NEC NL10276BC24-13 LCD panels were purchased from NEC Electronics America, Inc., P.O. Box 951154, Dallas, Tex. 75395-1154.

Toshiba LTD121 KM2M LCD panels were purchased from Toshiba America Electronic Components, P.O. Box 99421, Los Angeles, Calif. 90074.

What is claimed is:

1. An actinically curable adhesive composition comprising:
a) an aliphatic urethane acrylate having a plurality of ethylenically unsaturated groups;
b) a monofunctional monomer;
c) a photoinitiator;
d) a plasticizer; and
e) a chain transfer agent.

2. An actinically curable adhesive composition comprising:
a) an aliphatic urethane acrylate having a plurality of ethylenically unsaturated groups;
b) a monofunctional monomer selected from the group consisting of phenoxyethyl acrylate and trimethylolpropane formal acrylate;
c) a photoinitiator;
d) a plasticizer; and
e) a chain transfer agent.

3. An actinically curable adhesive composition comprising:
a) an aliphatic urethane acrylate having a plurality of ethylenically unsaturated groups;
b) a monofunctional monomer;
c) a photoinitiator selected from the group consisting of a difunctional alpha-hydroxy ketone, 1-hydroxycyclohexylphenyl ketone, and 2,4,6- trimethylbenzoylphenylphosphine oxide;
d) a plasticizer; and
e) a chain transfer agent.

4. An actinically curable adhesive composition comprising:
a) an aliphatic urethane acrylate having a plurality of ethylenically unsaturated groups;
b) a monofunctional monomer;
c) a photoinitiator;
d) a plasticizer; and
e) a chain transfer agent selected from the group consisting of pentaerythritol tetrakis(3-mercaptopropionate), 2-mercaptobenzothiazole, 2-mercaptobenzoxazole, 4-methyl-4H-1,2,4-triazole-3-thiol; N- phenylglycine, 1,1-dimethyl-3,5-diketocyclohexane, 2- mercaptobenzimidazole, pentaerythritol tetrakis (mercaptoacetate), 4- acetamidothiophenol, mercaptosuccinic acid, dodecanethiol, and beta- mercaptoethanol.

5. An actinically curable adhesive composition comprising:
a) an aliphatic urethane acrylate having a plurality of ethylenically unsaturated groups;
b) a monofunctional monomer;
c) a photoinitiator;
d) a plasticizer; and
e) pentaerythritol tetrakis(3-mercaptopropionate).

6. An actinically curable adhesive composition comprising:
a) an aliphatic urethane acrylate having a plurality of ethylenically unsaturated groups;
b) a monofunctional monomer;
c) a photoinitiator;
d) a plasticizer selected from the group consisting of dibutoxyethoxyethyl adipate and dibutoxyethoxyethyl formal; and
e) a chain transfer agent.

7. The actinically curable adhesive composition of claim 1, wherein the composition is reworkable.

8. The actinically curable adhesive composition of claim 1, wherein the composition in its actinically cured state and in use for bonding a glass plate to a front polarizer of an LCD exhibits a glow mark test rating of 2 or less in a glow mark test.

9. The actinically curable adhesive composition of claim 1, wherein the composition in its actinically cured state and in use for bonding a glass plate to a front polarizer of an LCD exhibits a pooling test rating of 1 (one) or less in a pooling test.

10. The actinically curable adhesive composition of claim 1, wherein level of the plasticizer is at least 10 weight percent.

11. The actinically curable adhesive composition of claim 10 wherein level of the plasticizer ranges from 10 weight percent to about 40 weight percent.

12. The actinically curable adhesive composition of claim 1, wherein level of the monomer is at least 10 weight percent.

13. The actinically curable adhesive composition of claim 12 wherein level of the monomer ranges from 10 weight percent to about 40 weight percent.

14. The actinically curable adhesive composition of claim 1 wherein level of the chain transfer agent ranges from about 4 weight percent to about 8 weight percent.

15. The actinically curable adhesive composition of claim 1 wherein level of the photoinitiator ranges from about 0.5 weight percent to about 2 weight percent.

16. The actinically curable adhesive composition of claim 1, wherein the composition upon curing exhibits a modulus of less than 0.35 Mpa.
